(19) United States
(12) Patent Application Publication
(10) Pub. No.: US 2011/0185840 A1
(43) Pub. Date: Aug. 4, 2011

(54) METHOD AND APPARATUS FOR AN INERTIAL DRIVE

(76) Inventor: Joseph P. Firmage, Salt Lake City, UT (US)

(21) Appl. No.: 12/903,155

(22) Filed: Oct. 12, 2010

Related U.S. Application Data
(60) Provisional application No. 61/278,772, filed on Oct. 9, 2009.
(60) Provisional application No. 61/339,498, filed on Mar. 8, 2010.

(51) Int. Cl. G01C 19/04

(52) U.S. Cl. 74/5 R

(57) ABSTRACT

A method of and apparatus for rectifying angular momentum of a rotating or spinning mass into linear acceleration forces includes a mass which is rotated about an axis of rotation which passes through the center of matter of the mass. This forms a gyroscope like rotating mass. The plane of rotation is perpendicular to the axis of rotation. The axis of rotation is moved in a manner to force precession of the rotating mass while holding the mass in relation to a frame of reference in a manner so that liner acceleration forces produced by the forced precession of the spinning mass are applied to the frame of reference. The spinning mass may be mounted in a frame of reference, such as a base to which the rectified angular momentum is to be applied, so that the center of matter of the rotating mass is in a fixed position with respect to a base forming a frame of reference. The forced precession of the rotating mass rectifies angular momentum of the rotating mass to create linear acceleration of the rotating mass and of the frame of reference in which the rotating mass is mounted. The invention also involves the controlling, powering, and utilizing of the axial dynamics of spinning matter for purposes of motion and energy control.

### PRIORITY CLAIM

Priority of U.S. Provisional Patent Applications Ser. No. 61/278,772 filed on Oct. 9, 2009 and Ser. No. 61/339,498 filed Mar. 8, 2010 are claimed, and such Provision Applications are hereby incorporated herein by reference in their entirety.

### BACKGROUND

1. Field of the Invention

The present invention relates generally to propellantless propulsion, i.e., the generation of linear motion on the basis of entirely self-contained, internal mass movements. More particularly, the present invention relates to propellantless propulsion obtained through manipulation of gyroscopic motion.

2. Related Art

Several researchers have claimed to have experimentally observed propellantless propulsion on the basis of specifically-tailored gyroscopic motions of masses internal to a vehicle to be propelled. See, for example, U.S. Pat. No. 3,653,269 to Foster, U.S. Pat. No. 5,090,260 to Delroy, and U.S. Pat. No. 7,383,747 to Tippett. Also see the article The Generation of a Unidirectional Force by Bruce E. DePalma available at http://depalma.pair.com/GenerationOfUnidrictionalForce.html. While the devices described in these patents and article apparently show the possibility of creating linear motion by manipulation of spinning masses, the devices shown and described as illustrating the principal, have not been satisfactorally put to practical use.

### SUMMARY OF THE INVENTION

According to the invention, a method of rectifying angular momentum of a rotating or spinning mass into linear acceleration force with respect to a frame of reference comprises obtaining a mass having a center of matter, spinning the mass about an axis of rotation that passes through the center of matter, forcing the mass to wobble in a controlled manner with respect to the frame of reference when rectification of the angular momentum of the spinning mass to linear acceleration is desired, and holding the mass with respect to the frame of reference in such manner that the linear forces created by the spinning mass during the controlled wobble of the mass are transferred to the frame of reference. In one aspect of the invention, the controlled wobbling of the spinning, mass is forced by continuously varying the angular orientation of the axis of rotation of the spinning mass in a regular manner with respect to the frame of reference while maintaining the center of matter of the spinning mass substantially fixed with respect to the frame of reference. A satisfactory regular manner of varying the angular orientation of the axis of rotation results in movement of the axis of rotation at a distance away from the center of matter in a circle. In one embodiment of the method, the spinning mass, also referred to as a rotating mass, is mounted for rotation in a plane of rotation about an axis of rotation which extends through the center of matter of the mass and which extends perpendicularly to the plane of rotation. The mass is positioned with respect to a body to be accelerated, which forms the frame of reference for the mass, so as to substantially fix the center of matter with respect to the body. Then, while spinning the mass and maintaining the center of matter substantially fixed with respect to the body, the axis of rotation of the mass is forced to precess creating the controlled wobble of the mass and the linear acceleration forces on the spinning mass which are transferred to the body. The forced precession of the axis of rotation of the rotating or spinning mass will be referred to as “streptation”. The method contemplates that a plurality of spinning masses will be positioned with respect to the body to be accelerated, and that each of the axes of rotation will separately be forced to precess. In this way, each of the spinning masses separately applies linear acceleration forces to the body and the masses can be arranged so that vibrations and forces in directions other than the desired linear direction will be substantially cancelled. The forces in the desired linear direction will be summed. Further, the precession forced on each of the spinning or rotating masses can be varied to provide control of the body in two or three dimensions through the acceleration forces applied to the body.

An apparatus of the invention includes a base, which forms the frame of reference, and a mass having an axis of rotation for spinning movement about the axis of rotation. Means is provided for causing spinning of the mass about the axis of rotation and means is provided for controllably forcing the mass to wobble in relation to the base. Means hold the mass in a position in relation to the base whereby longitudinal acceleration forces from the mass during forced wobble of the mass are transferred to the base. The longitudinal acceleration forces transferred to the base can result in longitudinal movement of the base.

A simple embodiment of a device of the invention includes a body to which linear accelerating force is to be applied. A mass having a center of matter, such as a disc, is mounted for rotation on a shaft which forms the axis of rotation and which passes through the center of matter of the mass and which is perpendicular to the plane of rotation of the mass. The rotating mass acts as a gyroscope. The shaft forming the axis of rotation is mounted in an apparatus that can force precession of the axis of rotation, which apparatus will be referred to herein as a “streptator”. The position of the center of matter of the rotatable mass is substantially fixed in the streptator. The streptator is mounted to the body through a mounting apparatus which fixedly positions the streptator, and thereby the center of matter of the rotatable mass, with respect to the body. With this substantially fixed positioning of the center of matter of the rotatable mass with respect to the body, any force applied by or movement of the center of matter of the rotatable mass will cause similar forces applied to or movement of the body.

In one embodiment of the device of the invention, the shaft forming the axis of rotation for the mass extends in opposite directions from the rotatable mass and the ends of the shaft are mounted to rotators which, when desired to rectify angular momentum of the rotation mass to linear acceleration force, rotate to move the ends of the shaft in respective circles. The shaft extends between opposite rotational orientations of the rotators so that with the rotators operating, the shaft continuously changes its angular orientation with respect to the body which continuously changes the angular orientation of the plane of rotation of the rotatable mass with respect to the body. This continuous changing of the angular orientation of the plane of rotation of the rotating mass is the forcing of precession of the rotating mass also referred to as the forcing of wobbling of the mass. This forced precession or “streptation” rectifies a portion of the angular momentum of the rotating mass to create linear acceleration of the rotating mass, which linear acceleration is applied through the center of matter of the rotating mass to the axle, which transfers the force to the body through the streptator and mounting apparatus.

A single combination of rotating mass and streptator, which can be referred to as a “spin drive column”, can be used alone and mounted to a body or base to which linear acceleration forces are to be applied, but the single combination, i.e., the single spin drive column, can vibrate causing the body or base to vibrate. If two or more combinations of rotating mass and streptator, i.e., two or more spin drive columns, are mounted to a body or base to which linear acceleration forces are to be applied, the multiple spin drive columns can be positioned in the body or base in such a manner to substantially counteract and cancel the respective vibrations and provide a smoother linear accelerating force. Generally with two spin drive columns, the spin drive columns will be arranged in parallel with the same direction of mass rotation, but opposite mass orientations. Any number of spin drive columns can be mounted to the body or base and can be mounted in various alignments with respect to the body or base so that linear forces may be applied and varied to cause movement of the body or base in a desired manner.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a block diagram of an embodiment of the method of the invention;

FIG. 2 is a schematic representation of an embodiment of a device of the present invention forming a single spin drive column;

FIG. 3 is a side elevation of a prototype of an embodiment of the invention using two spin drive columns;

FIG. 4 is an end elevation of the prototype of FIG. 3;

FIG. 5 is a schematic representation of an embodiment of the invention showing three spin drive columns;

FIG. 6 is a schematic representation of an embodiment of the invention showing four spin drive columns;

FIG. 7 is a schematic representation of an alternate embodiment of the invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

The invention includes a method for rectifying angular momentum of a rotating mass into linear acceleration force and apparatus for performing the method.

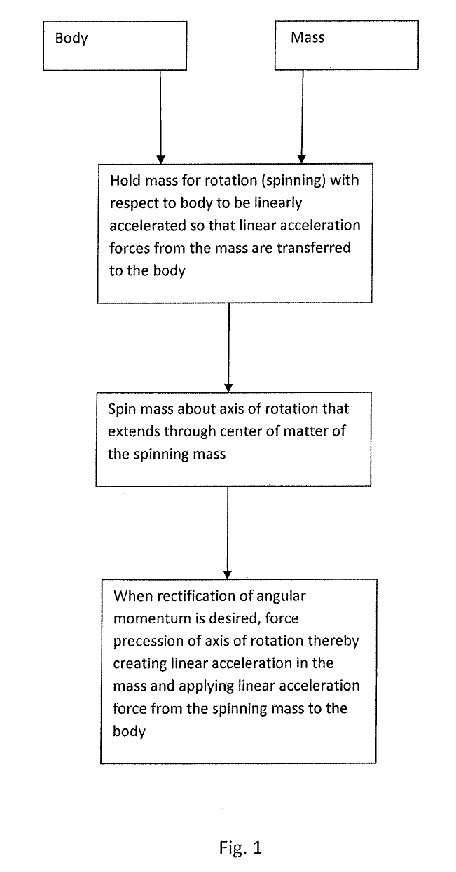

With reference to FIG. 1, an embodiment of the method includes determining a body to which linear acceleration force is to be applied and determining a mass with a center of matter which can be held with respect to the body so that linear acceleration forces from the mass are transferred to the body. Then, while rotating or spinning the mass, when rectification of rotational momentum of the mass is desired, the axis of rotation of the mass is forced to precess, i.e., the spinning mass is forced to wobble, creating linear acceleration forces on the center of matter of the rotating mass. The linear acceleration forces on the center of matter of the rotating mass are transferred to the body. When the mass is in a gravitational field, the center of matter of the mass will be the same as the center of gravity of the mass. In one aspect of the method, the center of matter of the spinning mass is held substantially fixed in relation to the body and is held so that the mass can rotate in a plane of rotation about an axis of rotation which extends through the center of matter of the mass and which extends perpendicularly to the plane of rotation. Then, when the axis of rotation of the mass is forced to precess creating linear acceleration forces on the center of matter of the rotating mass, since the center of mass is held substantially fixed in relation to the body, the linear acceleration forces on the center of matter of the rotating mass are transferred to the body.

In a simple mechanical application of the method, the mass is rotatably mounted to the body by a shaft that forms the axis of rotation and which is perpendicular to the plane of rotation of the mass. The shaft is mounted to the body so that ends of the shaft are moved to force precession of the shaft while the mass is spinning on the shaft, and the shaft is held in the body so that linear acceleration forces applied to the shaft are transferred to the body. The method, however, is not limited to practice through mechanical embodiments. The method can be practiced on a particle level where particles such as electrons, protons, and/or neutrons making up a body can be aligned and/or rotated by electrical or magnetic fields to cause movement of the body.

The method may include positioning additional rotating masses with respect to the body to apply additional linear accelerating forces to the body. If the axes of rotation of additional masses are directed to provide linear acceleration forces in substantially the same direction, the linear forces applied will be additive to increase the force applied to the body in the same direction. Also, the rotating masses and their respective streptators can be arranged and operated so that vibrations and forces in directions other than the desired linear acceleration force direction are cancelled resulting in a substantially smooth, unidirectional acceleration force applied to the body. If desired, the axes of rotation can be directed to apply forces in substantially different directions to provide particular desired control options. The number of mass-streptator combinations needed to power and control a body in a particular environment will depend upon whether or not there is gravity in the environment and the other control systems the body may have.

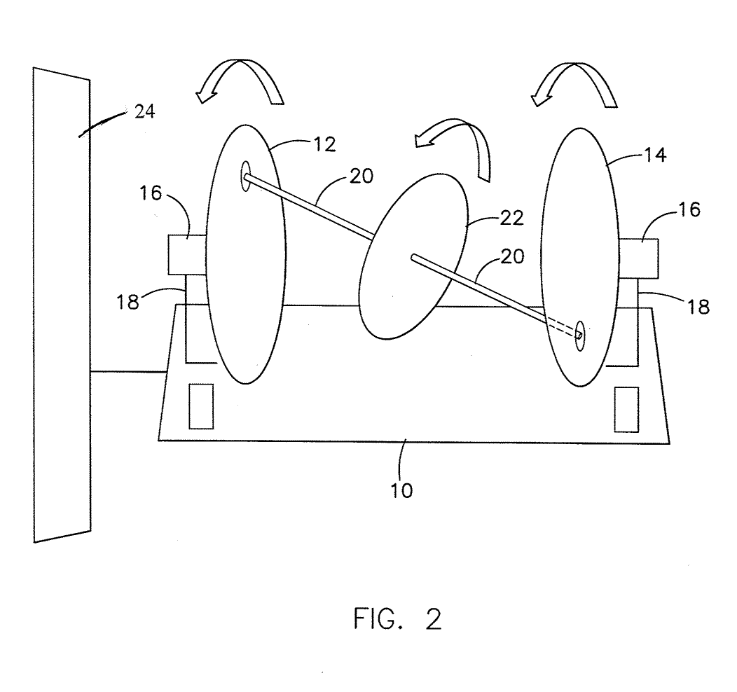

A simple mechanical embodiment of a device of the invention is shown in FIG. 2. The body to which linear acceleration forces are to be applied is shown as a flat base 10. The flat base 10 can be used for experimental purposes or it can represent any type of body such as an automobile of aircraft. A pair of rotators 12 and 14 are mounted for rotation to the output shafts of motors 16, which are rigidly mounted to base 10 by brackets 18. Motors 16 may include gear boxes so that the output shafts extend from the gear boxes. The output shafts of motors 16 are aligned. A shaft 20 is secured to extend between rotators 12 and 14 with opposite ends of the shaft secured to opposite angular orientations of the respective rotators. Thus, one end of shaft 20 is shown attached to the top portion of rotator 12 and the opposite end of shaft 20 is shown attached to the bottom portion of rotator 14. The points of attachment are positioned one hundred and eighty degrees apart around the rotators. With this arrangement, as the rotators are rotated, the ends of the shaft 20 will turn in a circle continuously changing the angular orientation of shaft 20 with respect to base 10. It is preferred that the attachments of the ends of the shaft to the rotators be fixed attachments so that the relationship between the two rotators is fixed, although such fixed attachments are not necessary. With the output shafts of motors 16 aligned, the center of shaft 20 will always remain in the same position with respect to base 10, i.e., the position of the center of the shaft 20 is in fixed position with respect to base 10. A mass, such as a disc 22 is mounted for rotation at the center of shaft 20 with shaft 20 passing through the center of matter of disc 22. Disc 22 is mounted so that shaft 20 always remains perpendicular to the plane of rotation of disc 22, and so that disc 22 will remain at the same position on shaft 20. In this manner, the center of matter of disc 22 is positioned in fixed relation to base 10. This also cants disc 22 with respect to rotators 12 and 14 and the axis of rotation of rotators 12 and 14. It should also be noted that as the ends of shaft 20 are rotated to change the angular orientation of the shaft with respect to the base, the plane of rotation of the disc 22 will also continuously change in relation to base 10.

In operation, the disc 22 will be rotated to spin on shaft 20. Various means can be used to cause rotation of disc 22. When disc 22 spins on shaft 20, it becomes a spinning gyroscope with all of the properties of a gyroscope. When the axis of rotation of disc 22 remains stationary, which occurs when there is no movement of shaft 20, mass 22 merely spins on shaft 20, and no linear forces are applied to the system. When it is desired to apply a linear acceleration force to base 10, motors 16 are energized to force precession of shaft 20, the axis of rotation of disc 22, i.e., the axis of rotation of the gyroscope formed by spinning disc 22. This forced precession of the axis of rotation of disc 22, rectifies some of the angular momentum of spinning disc 22 to linear acceleration force in the direction of the axis of rotation, i.e., in the direction of shaft 22. The particular direction of the linear acceleration will depend on the direction of rotation of the disc. Shaft 22 is mounted to rotators 12 and 14, which are mounted to motors 16 and brackets 18 in a manner that the linear acceleration forces applied along shaft 20 are transferred to base 10. The amount of linear acceleration force applied to shaft 20 and base 10 can be controlled by the speed of rotation of disc 22. The higher the speed of rotation of disc 22, the more linear acceleration force is applied for a given amount of forced precession. The speed of forced precession of shaft 20 may also have an effect. In particular, it has been found that, at least in some circumstances, increased force is applied when the shaft rotation speed (streptator speed) is the same as the speed of rotation of the disc. Also, the angle of shaft 20 can affect the amount of linear acceleration force applied, the greater the angle, the greater the force, although this will generally be factory set and not user adjustable. It has been found that angles of up to forty five degrees resulting in a change of the plane of rotation of ninety degrees operate satisfactorily. Further, the mass of disc 22 has an effect on force produced and it is generally preferred to make the disc 22 relatively heavy compared to the remaining parts, i.e., the rotators. Thus, the mass of the rotating mass should be maximized, and maximized toward the outer rim of the disc, while the mass of the surrounding apparatus should be minimized.

In one form of testing of a device as shown in FIG. 2, the base 10 can be suspended for substantially free lateral movement with base 10 attached to a fixed scale 24. Scale 24 can then measure and indicate the force exerted by base 10, depending upon the type of scale 24, in a direction away from the scale, toward the scale, or in directions both away from and toward the scale 24. The orientation of the device and scale can be changed in a manner as illustrated if FIG. 2 is rotated ninety degrees counterclockwise, so that the device is arranged to provide linear acceleration forces in vertical up or down directions, with scale 24 measuring the up or down forces applied.

In a test of a device as shown in FIG. 2 with a single rotating mass, the device was securely suspended by a flexible cable from a ceiling suspension hook. The device was not attached to scale 24. A pointer was attached to the base and projected a light spot onto a wall. The disc 22 was a twenty inch disc weighing one hundred pounds. The disc was not separately and continuously powered. The disc was brought up to a speed of about one thousand rpm. Once up to speed, the rotators were operated at a speed of sixteen rpm. The pointer was about twenty five feet from the wall and produced an oval pattern on the wall about fifteen feet wide and one foot high. This was with co-streptation which means that the disc and the rotators all rotate in the same direction. Interestingly, when counter streptation was used, i.e., the disc was rotated in the opposite direction from the rotators, the device experienced much greater turbulence and created a pattern on the wall three to four times as large as during co-streptation. With the rotators operating at sixteen rpm, it took about one hundred seconds for the rotation of the disc to stop. When the speed of rotation of the rotators was about tripled, the duration of spinning of the disc was cut to about one third, or about thirty three seconds. This is an indication that the streptation of the gyroscope is taking energy from the gyroscope and putting it into linear force.

FIG. 2 shows a single disc and streptator combination mounted on the base. Thus, FIG. 2 shows a single rotating or spinning disc 22 acting as a gyroscope as it spins on shaft 20 which extends between the rotators 12 and 14, which rotators, together with motors 16 which rotate the rotators 12 and 14, form the illustrative representation of the streptator. This single spinning disc and single streptator combination can be called a “streptation propulsion engine”, or more simply, as it will be referred to herein, can be called a “spin drive column”.

The single spin drive column is rigidly secured to base or body 10. The single spin drive column illustrated will show a counter-rotational effect caused as the rotators resist applied torque from the motors, and as the motor shafts themselves apply resistance to the induction process. Further, since the linear acceleration forces are applied from the spinning mass through the axle of rotation, so are applied at angles to the rotators and the axis of rotation of the rotators, and thus at angles to the base to which the spin drive column is attached, the spin drive column does not apply a smooth, single direction linear acceleration force to the base. Linear acceleration forces of varying angles, vibrations, and counter-rotational artifacts are all applied from the spin drive column to the base. One way to address these varying forces, vibrations, and counter-rotational artifacts is to mount more that a single spin drive column to the base. If more than one spin drive column is mounted on the base, the multiple spin drive columns can be mounted to counteract and reduce the effects of the varying angles of linear forces, vibrations, and counter-rotational artifacts of each of the single engines. By mounting multiple spin drive columns on a single base, the multiple spin drive columns can be arranged with respect to one another so that the base provides a substantially smooth and controllable linear directional acceleration force.

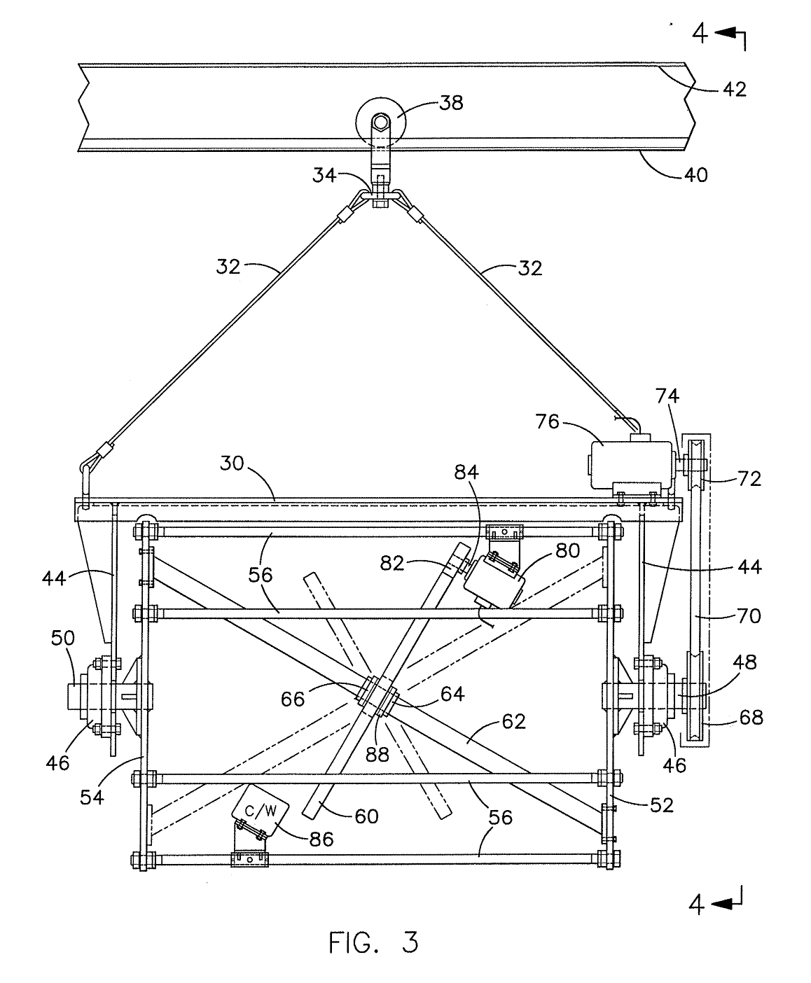

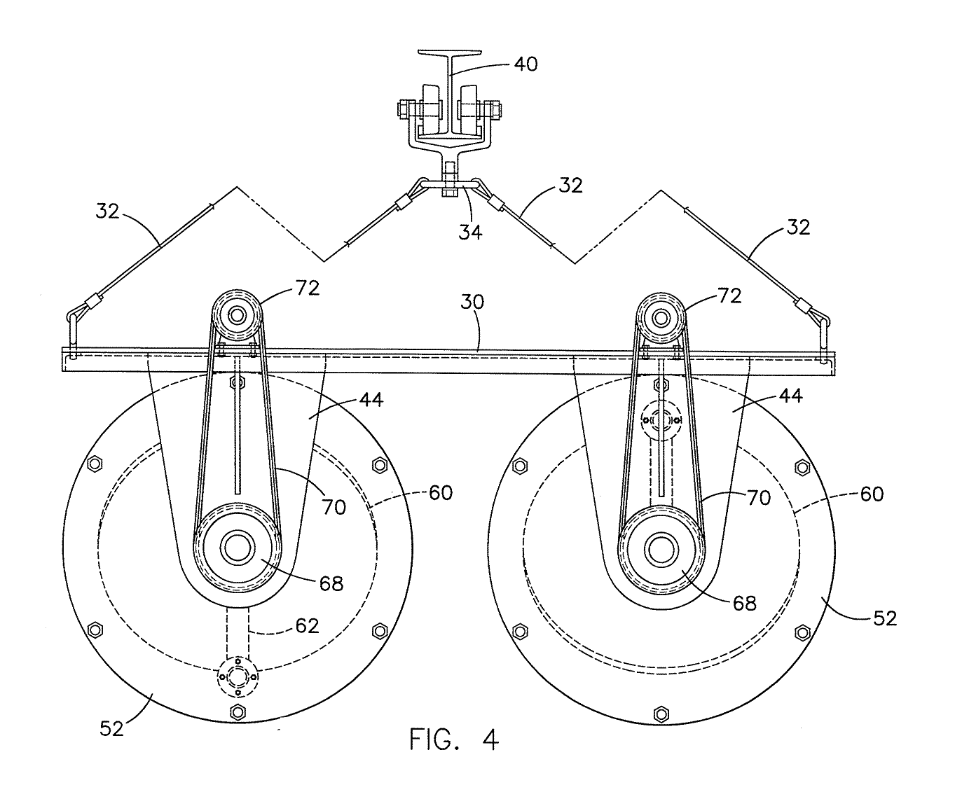

FIGS. 3 and 4 show a prototype device used for testing the invention. A body or base 30 is suspended by cables 32 from a ring mount 34, which is suspended from a wheeled carriage 38 mounted for linear movement along a track 40 secured to a ceiling 42. Brackets 44 extend from base 30 with bearings 46 which rotatably support axles 48 and 50 extending from rotators 52 and 54. Rotators 52 and 54 are each in the form of discs. Rotators 52 and 54 are secured together by rods 56 to form rotatable drum like structures. A disc 60 is mounted for rotation on shaft 62 by bearing 64. Disc 60 is mounted midway along the length of shaft 62 and is held in position along the length of shaft 62 by thrust bearings 66. In this way, shaft 62 always extends perpendicular to the plane of rotation of disc 60. Further, disc 60 cannot slide along shaft 62 so that any linear force generated by disc 60 is transferred directly to shaft 62. One end of shaft 62 is secured near an edge of rotator 52 while the other end of shaft 62 is secured near an edge of rotator 54, but at a position spaced one hundred and eighty degrees around rotator 54. Thus, shaft 62 extends at an angle with respect to base 30 and with the axis of rotation for rotators 52 and 54 formed by axles 48 and 50. A pulley 68 is mounted on axle 48, with a belt 70 extending from pulley 68 to pulley 72 mounted on motor shaft 74 of variable speed motor 76. Thus, operation of motor 76 will cause rotation of the drum like structure formed by rotators 52 and 54 and rods 56. This drum like structure with shafts 48 and 50 and motor 76 with belt drive to rotate the drum like structure forms the streptator which forces precession of the axis of rotation of disc 60 formed by shaft 62.

With the construction of the drum like structure mounting shaft 62 and disc 60, disc 60 will be fixed in position with respect to the drum like structure. Therefore, disc 60 can be driven to rotate by a motor 80 secured to one of the rods 56 with a drive wheel 82 secured to motor shaft 84 positioned to contact the circumferential edge of disc 60. As motor shaft 84 and drive wheel 82 rotate, disc 60 will be rotated. Since motor 80 will rotate with the streptator as and when it rotates, motor 80 may be battery powered so that electrical connections to the motor are not needed. However, outside electrical connections could be provided, if desired, through commutators and brushes provided on one of the rotators 52 or 54, or by other suitable means. With a motor 80 attached to the drum structure on one side, a counter weight 86 is mounted on the opposite side in similar manner to the motor to balance the assembly.

During operation of the device, disc 60 is rotated on shaft 62. As long as disc 60 and shaft 62 remain in the same position, such as the position shown in solid lines in FIG. 3, no linear acceleration forces are generated by disc 60, so no linear acceleration forces are applied to body 30. When it is desired to apply linear acceleration forces to body 30, motor 76 is operated to cause rotation of the drum like structure of the streptator. The rotation of rotators 52 and 54 move the ends of shaft 62 in a continuous regular circular motion which changes the angle of shaft 62, the axis of rotation of disc 60, with respect to body 30 in a continuous regular manner. The broken lines in FIG. 3 show the position of disc 60 after 180 degrees of rotation of the streptator. This causes rectification of a portion of the angular momentum of rotating disc 60 to linear acceleration forces which are applied from disc 60, by way of shaft 62, discs 52 and 54, axles 48 and 50, and brackets 44 to body 30.

The embodiment of FIGS. 3 and 4, see FIG. 4, show two disc and streptator combinations, i.e., two spin drive columns, mounted on base 30. With the two spin drive columns positioned side-by-side as shown in FIG. 4, and discs 60 in each spin drive column arranged to rotate in the same direction, each combination will produce linear acceleration forces in the same direction. Further, if the streptators are arranged rotationally to position discs 60 with opposite orientations as shown by the solid and broken lines in FIG. 3, the two spin drive columns will tend to cancel out vibrations and linear forces in directions other than a single linear direction to move the device along track 40. By changing parameters of one or the other of the spin drive columns so as to change the amount of force provided by one of the spin drive columns with respect to the other, such as by changing the speed of rotation of one of the streptators, the base 30 can be made to rotate in one or the other direction. It is noted that motors 76 may be variable speed motors so the respective speeds of rotation of the streptators can be changed.

While the device of FIGS. 3 and 4 is shown suspended from a track so that it can move along the track, this is merely and experimental set up for testing the device shown and described. A device as shown in FIGS. 3 and 4, or as shown schematically in other Figs., can be constructed without attachments to tracks or scales and in a manner to provide an inertial engine to be placed in an automobile, train, airplane, space ship, or similar vehicle.

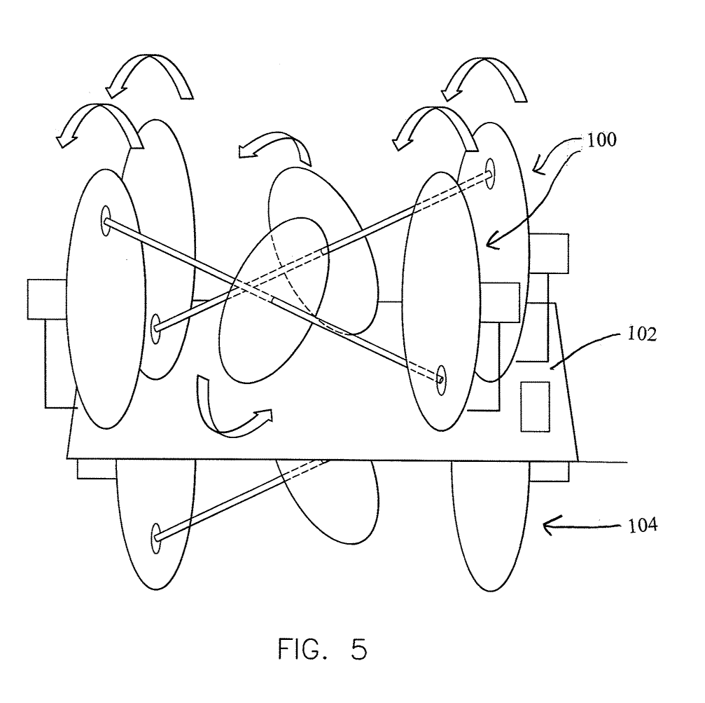

FIG. 5 schematically shows a device of the invention wherein three spin drive columns are mounted to the base. Two spin drive columns 100 are mounted on top of the base 102 and a third spin drive column 104 is mounted below the base 102. The two spin drive columns 100 on top of the base can be attenuated so as to cancel virtually all lateral oscillations and counter-rotational artifacts. Note that the orientation of the spinning discs of the two spin drive columns 100 are of opposite orientation. The third spin drive column 104 underneath the base 102 can be attenuated so as to counter-balance the vertical component of the oscillations of the spin drive columns above. To accomplish this balancing function, however, programmed or other real time responsive RPM control of the spin drive columns is required.

With this three spin drive column embodiment, all three spin drive columns can provide longitudinal impulse in a common direction, or one or two of the spin drive columns may be attenuated such that, in combination, “pitch, roll, and yaw” control may be accomplished on or in any medium: land sea, air, and space. Three spin drive columns is the minimum number of spin drive columns required to provide this level of three dimensional space control.

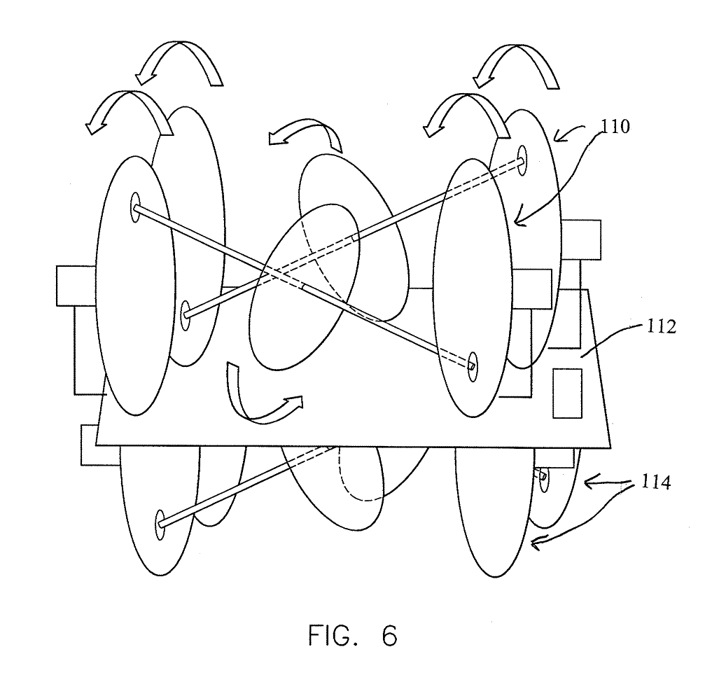

FIG. 6 schematically shows a device of the invention wherein four spin drive columns are mounted to the base. Two spin drive columns 110 are mounted on top of the base 112 and two spin drive columns 114 are mounted below the base 112. Here, note that the orientation of the spinning discs of the two spin drive columns 110 above the base and of the two spin drive columns below the base are of opposite orientation. Further, the orientation of two spinning discs of the two spin drive columns directly above and below the base are of opposite orientation. With this four spin drive column embodiment, each pair of spin drive columns operate in rectangle when viewed head or tail on. This can eliminate many difficulties of a three spin drive column design as shown in FIG. 5. This four spin drive column embodiment eliminates the need to use one spin drive column below the base to compensate for two spin drive columns above the base that are not vertically aligned with it, and having to attenuate the relative “pointing and power” of the spin drive columns above the base to compensate for the counter-rotational torque operating in just one spin drive column below the base. The four spin drive column design currently appears to be the minimally ideal configuration.

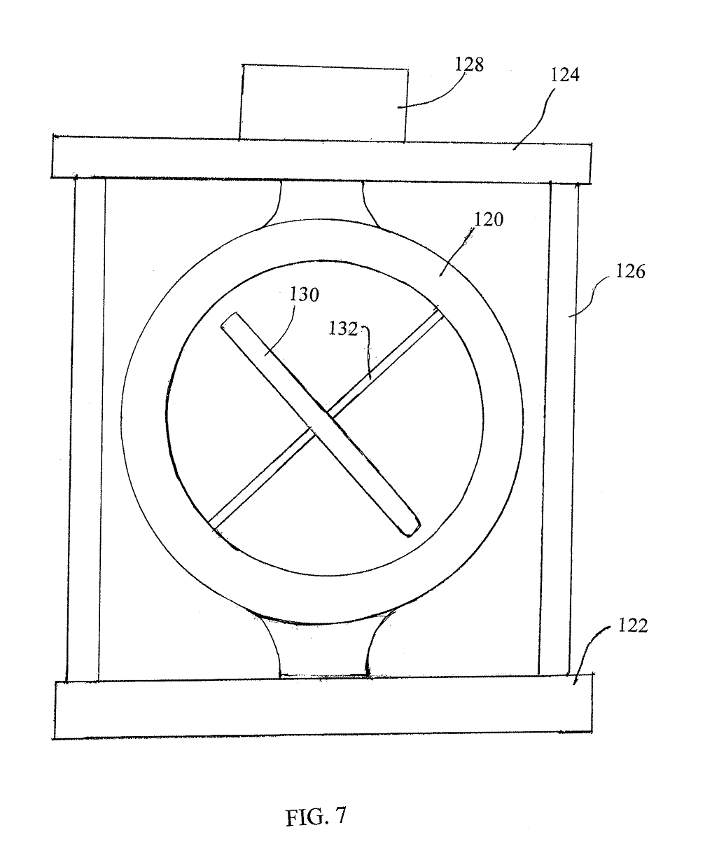

FIG. 7 schematically shows an alternate mechanical embodiment of the invention. In the embodiment of FIG. 7, rather than two separate streptator rotators holding the ends of the shaft mounting the spinning disc, the streptator includes a streptator ring 120 mounted for rotation between support plates 122 and 124. Rotation of the streptator ring in the embodiment of FIG. 7 is about a diameter of the streptator ring extending between the support plates plates. Support plates 122 and 124 are secured together in spaced relationship by posts 126. A motor unit 128, shown here as mounted on top support plate 124 provides power to rotate streptator ring 120. Spinable mass in the form of disc 130 is mounted for rotation on shaft 132 which is mounted in streptator ring 120 at an angle with respect to support plates 122 and 124 so as to cant disc 130 with respect to support plates 122 and 124. Various means can be provided to spin disc 130 on shaft 132 within streptator ring 120. When rectification of angular momentum from spinning disc 130 is desired, streptator ring 120 is rotated between support plates 122 and 124. This rotation of the streptator ring 120 provides the same streptation as previously described to provide linear acceleration forces on support plates 122 and 124 similar to the linear acceleration forces provided on rotators 12 and 14 of FIG. 2. The embodiment of FIG. 7 merely provides an alternate way of mounting the spinning disc or gyroscope for streptation.

As indicated above, the invention is not limited to practice through mechanical embodiments. The invention can be practiced on a particle level where rotation of particles such as electrons, protons, and/or neutrons making up a body can be aligned and streptated by electrical or magnetic fields, or by other means, to cause movement of the body or other effects and results.

It is interesting to note the concept of “nutation” which refers to natural, uncontrolled precession in the absence of gravity or other imposition. As used in this application and invention, strptation is substantially the opposite of nutation, or can be considere as “imposed nutation”. Nutation is the witnessing, allowing, or otherwise measuring precession for purposes of damping its dynamic. Streptation is the controlling, powering, and utilizing of the axial dynamics of spinning matter for purposes of motion and energy control. The present invention involves control of axial dynamics of spinning matter, including in the nanometer and atomic particle ranges. The expected results of the invention on that level include reversal of various current procedures. For example, currently NMR (nuclear magnetic resonance) is monitored through MRI (magnetic resonance imaging) so that the results of the NMR are displayed and observed through MRI on a computer screen. The reversal of this as contemplated by this invention is to construct MRI like structures using the computer screen and computer and use this to drive and affect the axial dynamics of spinning matter.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method of rectifying angular momentum of a spinning mass into controlled linear acceleration force with respect to a frame of reference, comprising:
obtaining a mass having a center of matter;
spinning the mass about its center of matter;
forcing the mass to wobble with respect to the frame of reference in a controlled manner when linear acceleration force is desired; and
holding the mass in the frame of reference in a manner so that liner acceleration forces produced by the wobbling spinning mass are applied to the frame of reference.

2. A method of rectifying angular momentum of a rotating mass into linear acceleration force with respect to a frame of reference, comprising:
continuously varying the angular orientation of the axis of rotation of a spinning mass in a regular manner with respect to the frame of reference during the time that rectification is desired while maintaining the center of matter of the spinning mass substantially fixed with respect to the frame of reference.

3. A method of rectifying angular momentum of a rotating mass into linear acceleration force with respect to a frame of reference, according to claim 2, wherein the regular manner of varying the angular orientation of the axis of rotation moves the axis of rotation at a distance away from the center of gravity in a circle.

4. A method of rectifying angular momentum of a rotating mass into linear acceleration force comprising:
positioning a mass having a center of matter for rotation in a plane of rotation about an axis of rotation extending through its center of matter and being perpendicular to the plane of rotation;
fixing the center of matter with respect to a frame of reference;
rotating the mass about the axis of rotation and the center of matter;
forcing precession of the rotating mass without moving the center of matter with respect to the frame of reference when rectification of angular momentum of the rotating mass to linear force is desired.

5. A method of rectifying angular momentum of a rotating mass into linear acceleration force according to claim 4, wherein the step of forcing precession of the rotating mass includes the step of moving the axis of rotation with respect to the frame of reference to continually vary the orientation of the axis and of the plane of rotation with respect to the frame of reference while maintaining the center of matter in substantially fixed position with respect to the frame of reference.

6. A method of rectifying angular momentum of a rotating mass into linear acceleration force according to claim 5, wherein the step of moving the axis of rotation with respect to the frame of reference to continually vary the orientation of the axis and of the plane of rotation with respect to the frame of reference moves the axis of rotation at a distance away from the center of gravity in a circle.

7. A device for producing controlled longitudinal acceleration forces, comprising:
a base;
a mass mounted for spinning movement about an axis of rotation;
means for causing spinning of the mass about the axis of rotation;
means for holding the mass in relation to the base; and
means for controllably forcing the mass to wobble in relation to the base whereby acceleration forces of the mass during forced wobble of the mass are transferred to the base through the means for holding the mass in relation to the base.

8. A device for producing controlled longitudinal acceleration forces and controlled longitudinal movement of the device resulting from the controlled longitudinal acceleration forces, comprising:
a base;
a mass having an axis of rotation for spinning movement about the axis of rotation;
means for causing spinning of the mass about the axis of rotation;
means for controllably forcing the mass to wobble in relation to the base; and
means for holding the mass in a position in relation to the base whereby acceleration forces of the mass during forced wobble of the mass are transferred to the base to cause longitudinal movement of the base.

9. A device for rectifying angular momentum of a rotating mass into linear acceleration force comprising:
a body to which linear acceleration force is to be applied;
a mass having a center of matter;
a shaft mounting the mass for rotation in a plane of rotation, the shaft forming an axis of rotation extending through the center of matter of the mass and the shaft extending in a plane perpendicular to the plane of rotation;
means mounting the shaft in the body, substantially fixing the center of matter of the mass with respect to body, and for forcing precession of the rotating mass without moving the center of matter with respect to the frame of reference when rectification of angular momentum of the rotating mass to linear force is desired.

10. A device for rectifying angular momentum of a rotating mass into linear acceleration force according to claim 9, wherein the shaft mounting the mass has opposite shaft ends, and wherein the means for forcing precession includes means for continuously varying the angle of the shaft with respect to the body.

11. A device for rectifying angular momentum of a rotating mass into linear acceleration force according to claim 10, wherein the means for continuously varying the angle of the shaft with respect to the body includes a rotator at each end of the shaft for continuously varying the angle of the shaft with respect to the body during operation of the rotators.

12. A device for rectifying angular momentum of a rotating mass into linear acceleration force according to claim 11, wherein the rotators are adapted to rotate in unison about a common axis of rotation to thereby move the opposite shaft ends in respective circles.

13. A device for rectifying angular momentum of a rotating mass into linear acceleration force according to claim 12, wherein the rotators are secured together as a unit.

14. A device for rectifying angular momentum of a rotating mass into linear acceleration force according to claim 12, wherein speed of the rotators can be varied.

15. A device for rectifying angular momentum of a rotating mass into linear acceleration force according to claim 10, wherein the means for continuously varying the angle of the shaft with respect to the body includes a streptator ring mounting the opposite ends of the shaft to the ring, said shaft being mounted in the streptator ring to be at an angle to the body, and means for rotating the streptator ring about a diameter of the ring to thereby continuously vary the angle of the shaft with respect to the body during rotation of the ring.

16. A device for rectifying angular momentum of a rotating mass into linear acceleration force according to claim 15, wherein speed of rotation of the streptator ring can be varied.

17. A device for rectifying angular momentum of a rotating mass into linear acceleration force according to claim 10, additionally including means for varying the speed of rotation of the mass.

18. A method of controlling motion and energy comprising the steps of aligning axes of rotation of the spinning matter and imposing desired precession to such axes of rotation.
